(19) United States
(12) Patent Application Publication
(10) Pub. No.: US 2020/0120704 A1
(43) Pub. Date: Apr. 16, 2020

(54) METHODS AND DEVICES FOR TRANSMITTING AND RECEIVING A SCHEDULING REQUEST

(71) Applicant: NEC CORPORATION, Tokyo (JP)

(72) Inventors: Yueyu WANG, Beijing (CN); Fang YUAN, Beijing (CN); Gang WANG, Beijing (CN)

(73) Assignee: NEC CORPORATION, Tokyo (JP)

(21) Appl. No.: 16/621,507

(22) PCT Filed: Jun. 14, 2017
(86) PCT No.: PCT/CN2017/088302

§ 371 Date: Dec. 11, 2019

(51) Int. Cl. H04W 72/12; H04L 5/00; H04L 27/00; H04B 7/06; H04W 76/19

(52) U.S. Cl. CPC H04W 72/1284; H04L 5/0053; H04L 5/0048; H04W 72/0446; H04B 7/0695; H04W 76/19; H04L 27/0008

(57) ABSTRACT

Embodiments of the present disclosure relate to a method, terminal device and apparatus for transmitting a scheduling request (SR) and a method, network device and apparatus for receiving the SR. In an embodiment of the present disclosure, the method of transmitting SR comprises transmitting a scheduling request, wherein the scheduling request contains at least one additional bit to indicate additional information. With embodiments of the present disclosure, there is provided a suitable SR transmission and receiving solution for the NR system which can meet requirements for the newly introduced functionality.

### FIELD OF THE INVENTION

The non-limiting and exemplary embodiments of the present disclosure generally relate to the field of wireless communication techniques, and more particularly relate to a method, terminal device and apparatus for transmitting a scheduling request, and a method, network device and apparatus for receiving a scheduling request.

### BACKGROUND OF THE INVENTION

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

In the Long Term Evolution (LTE) system, a scheduling request (SR) is used to request a resource scheduling when a terminal device is in a connected state and the SR is carried on the physical uplink control channel (PUCCH). In the LTE system, the SR requests a resource scheduling by providing energy on the corresponding PUCCH.

In 3GPP RANI #88 meeting, there was an agreement that the SR was not precluded for beam failure recovery in the NR system; and, in 3GPP RANI #89 meeting, it was agreed that the PUCCH can be used for beam failure recovery. Thus, This means that a new functionality might be introduced into the SR.

However, due to introduction of new functionality of the SR in the NR system, the current SR solution cannot meet requirements of the NR system any longer and thus there is a need for a new solution of SR transmission in the art.

### SUMMARY OF THE INVENTION

To this end, in the present disclosure, there is provided a new solution for PRACH transmission and receiving, to mitigate or at least alleviate at least part of issues in the prior art.

According to a first aspect of the present disclosure, there is provided a method of transmitting a scheduling request. The method may comprise transmitting a scheduling request, wherein the scheduling request contains at least one additional bit to indicate additional information.

According to a second aspect of the present disclosure, there is provided a method of receiving a scheduling request. The method may comprise receiving a scheduling request, wherein the scheduling request contains at least one additional bit to indicate additional information and detecting the additional information from the at least one additional bit.

According to a third aspect of the present disclosure, there is provided a terminal device. The terminal device may comprise a transceiver configured to transmit a scheduling request, wherein the scheduling request contains at least one additional bit to indicate additional information.

According to a fourth aspect of the present disclosure, there is provided a network device. The network device may comprise a transceiver configured to receiving a scheduling request, wherein the scheduling request contains at least one additional bit to indicate additional information; and a controller configured to detect the additional information from the at least one additional bit.

According to a fifth aspect of the present disclosure, there is provided a terminal device. The terminal device may comprise a processor and a memory. The memory may be coupled with the processor and have program codes therein, which, when executed on the processor, cause the terminal device to perform operations of the first aspect.

According to a sixth aspect of the present disclosure, there is provided a network device. The network device may comprise a processor and a memory. The memory may be coupled with the processor and having program codes therein, which, when executed on the processor, cause the network device to perform operations of the second aspect.

According to a seventh aspect of the present disclosure, there is provided a computer-readable storage media with computer program code embodied thereon, the computer program code configured to, when executed, causes an apparatus to perform actions in the method according to any embodiment in the first aspect.

According to an eighth aspect of the present disclosure, there is provided a computer-readable storage media with computer program code embodied thereon, the computer program code configured to, when executed, causes an apparatus to perform actions in the method according to any embodiment in the second aspect.

According to a ninth aspect of the present disclosure, there is provided a computer program product comprising a computer-readable storage media according to the seventh aspect.

According to a tenth aspect of the present disclosure, there is provided a computer program product comprising a computer-readable storage media according to the eighth aspect.

With embodiments of the present disclosure, there is provided a suitable SR transmission and receiving solution for the NR system which can meet requirements for the newly introduced functionality.

### BRIEF DESCRIPTION OF THE DRAWINGS

The above and other features of the present disclosure will become more apparent through detailed explanation on the embodiments as illustrated in the embodiments with reference to the accompanying drawings, throughout which like reference numbers represent same or similar components and wherein:

FIG. 1 schematically illustrates an example SR procedure in the LTE system;

FIG. 2 schematically illustrates a table of PUCCH formats in the LTE system;

FIG. 3 schematically illustrates an example mapping of SR onto the time-frequency resource in LTE system;

FIG. 4 schematically illustrates a flow chart of a method of transmitting SR at a terminal device according to an embodiment of the present disclosure;

FIG. 5 schematically illustrates an example mapping of SR onto the time-frequency resource according to an embodiment of the present disclosure;

FIG. 6 schematically illustrates an example SR procedure in the NR system according to an embodiment of the present disclosure;

FIGS. 7A and 7B schematically illustrate example SR transmissions according to embodiments of the present disclosure;

FIGS. 8A and 8B schematically illustrate example SR resource mappings according to embodiments of the present disclosure;

FIG. 9 schematically illustrates another example mapping of SR onto the time-frequency resource according to an embodiment of the present disclosure;

FIGS. 10A and 10B schematically illustrate example modulation modes according to embodiments of the present disclosure;

FIG. 11 schematically illustrates example SR transmissions according to embodiments of the present disclosure;

FIG. 12 schematically illustrates a further example mapping of SR onto the time-frequency resource according to an embodiment of the present disclosure;

FIG. 13 schematically illustrates another SR procedure according to an embodiment of the present disclosure.

FIGS. 14A to 14C schematically illustrate example SR transmission counting according to embodiments of the present disclosure;

FIG. 15 schematically illustrates a flow chart of a method of receiving SR at a network device according to an embodiment of the present disclosure;

FIG. 16 schematically illustrates an apparatus for transmitting SR at a terminal device according to an embodiment of the present disclosure;

FIG. 17 schematically illustrates an apparatus for receiving SR at a network device according to an embodiment of the present disclosure; and

FIG. 18 further illustrates a simplified block diagram of an apparatus 1810 that may be embodied as or comprised in a network device ((like gNB), and an apparatus 1820 that may be embodied as or comprised in a terminal device like UE as described herein.

### DETAILED DESCRIPTION OF EMBODIMENTS

Hereinafter, the solution as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc.]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, user equipment (UE) may refer to a terminal, a Mobile Terminal (MT), a subscriber station, a portable subscriber station, Mobile Station (MS), or an Access Terminal (AT), and some or all of the functions of the UE, the terminal, the MT, the SS, the portable subscriber station, the MS, or the AT may be included. Furthermore, in the context of the present disclosure, the term “BS” may represent, e.g., a node B (NodeB or NB), an evolved NodeB (eNodeB or eNB), gNB (next generation Node B), a radio header (RH), a remote radio head (RRH), a relay, or a low power node such as a femto, a pico, and so on.

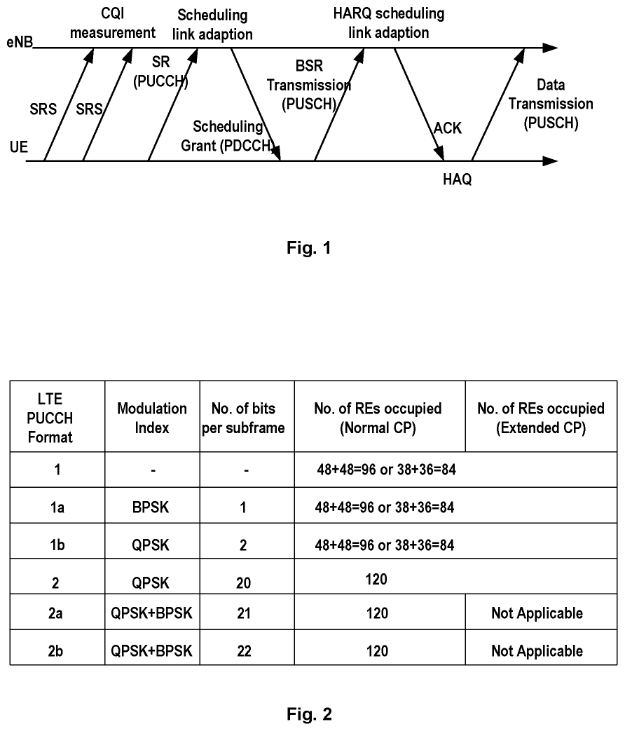

As already mentioned, in the LTE system, the scheduling request is used to request a resource scheduling when a terminal device is in a connected state and the SR is carried on the physical uplink control channel (PUCCH). For illustration purposes, reference will be first made to FIGS. 1 to 3 to describe the solution of SR in the LTE system.

FIG. 1 illustrates an example SR procedure in the LTE system. As illustrated in FIG. 1, the terminal device like UE transmits sounding reference signals (SRS) to the network device like eNB. The eNB performs CQI measurement based on the SRS. The UE sends an SR on PUCCH to eNB to request transmission resource. After a scheduling link adaption, the eNB may transmit to the UE a scheduling grant on physical downlink control channel (PDCCH). In response to the scheduling grant, the UE may transmit a buffer state report (BSR) on a physical uplink shared channel (PUSCH) to the eNB so that the eNB could know the source that the terminal device requires. The eNB allocates resource for the uplink transmission based on the BSR and transmits an ACK to the terminal device. Upon receiving the ACK from the eNB, the terminal device may begin the UL data transmission on PUSCH.

FIG. 2 illustrates a table of PUCCH format in the LTE system. In table as illustrated in FIG. 2, there are shown different PUCCH formats, containing formats 1, 1a, 1b, 2, 2a and 2b. Amongst other things, format 1 is a PUCCH format for the SR, which carriers no more information on resource elements (REs) for SR. In other words, the present of energy on the corresponding PUCCH means a SR and no further information is carried.

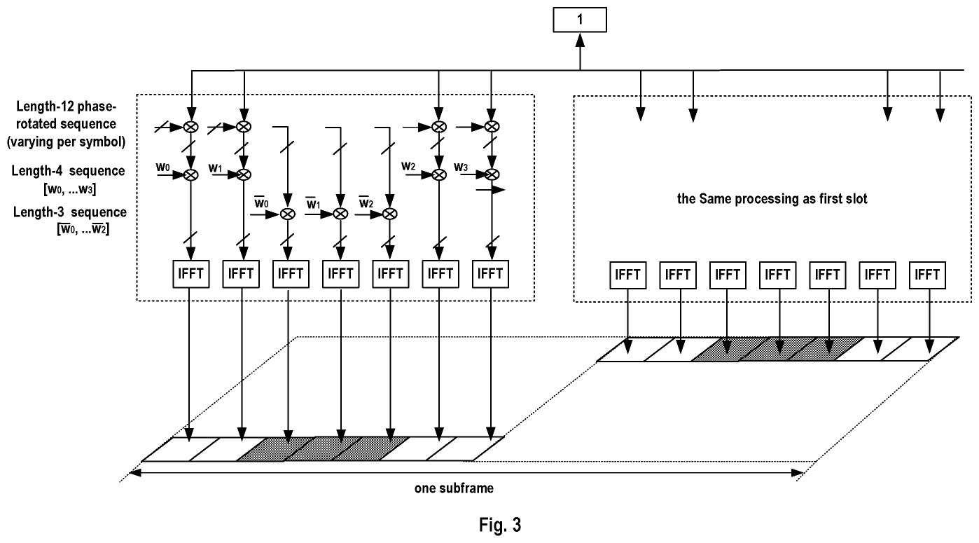

FIG. 3 illustrates an example mapping of SR onto the time-frequency resource in LTE system. As illustrated in FIG. 3, the signal for SR will be first phase-shifted by a sequence with a length of 12 which varies per symbol and multiplied by a sequence [w0, w1, w2, w3]. After the IFFT, it is mapped to corresponding symbols for the PUCCH, for example, the first two symbols and the last two symbols in a slot as illustrated in FIG. 3. By detecting energy on these symbols, the eNB can identify a SR transmission.

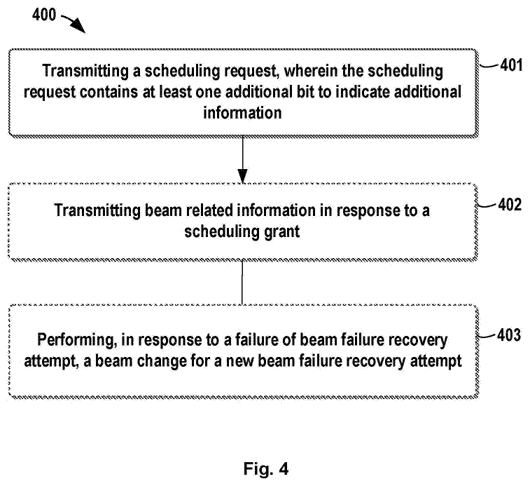

However, due to introduction of new functionality of the SR in the NR system, the current SR cannot meet requirements of the NR system. Thus, in the present disclosure, there is provided a new solution of SR. In the present disclosure, it is proposed to extend the SR to contain at least one additional bit to indicate more information so that it can be adapted to the introduction of new functionality of the SR, or even further more other functionalities, operations, or actions. Hereinafter, reference will be made to FIGS. 4 to 18 to describe embodiments of the present disclosure in details.

FIG. 4 schematically illustrates a flow chart of a method of transmitting SR at a terminal device according to an embodiment of the present disclosure. The method 400 can be performed at a terminal device, for example UE, or other like terminal devices.

As illustrated in FIG. 4, first in step 401, the terminal device may transmit a scheduling request, wherein the scheduling request contains at least one additional bit to indicate additional information. This means that different from the conventional SR, the scheduling request as proposed herein may contain at least one additional bit indicating additional information, for example to indicate the SR is used for the resource scheduling or a beam failure recovery.

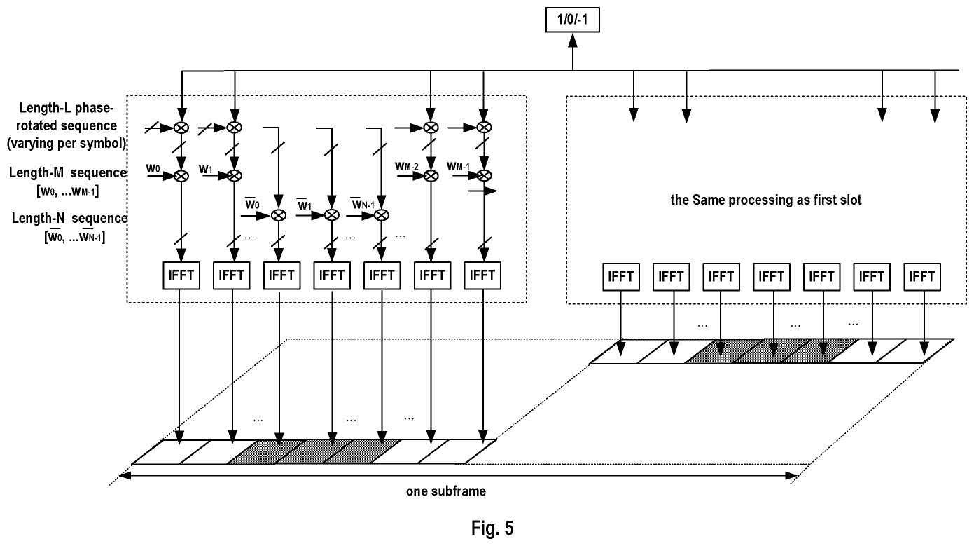

FIG. 5 illustrates an example mapping of SR onto the time-frequency resource according to an embodiment of the present disclosure. In FIG. 5, the main difference from the LTE system lies in that the SR now has an additional bit which could further indicate for example, −1, instead of only the presence or absence of the energy. For example, the value “0” can be used to indicate the absence of energy on the PUCCH, values “1” and “−1” can be used to indicate the presence of the energy and the uses of the SR. For example, the value “1” may be used to indicate a resource scheduling request or a resource request while the value “−1” may be used to indicate a beam failure recovery.

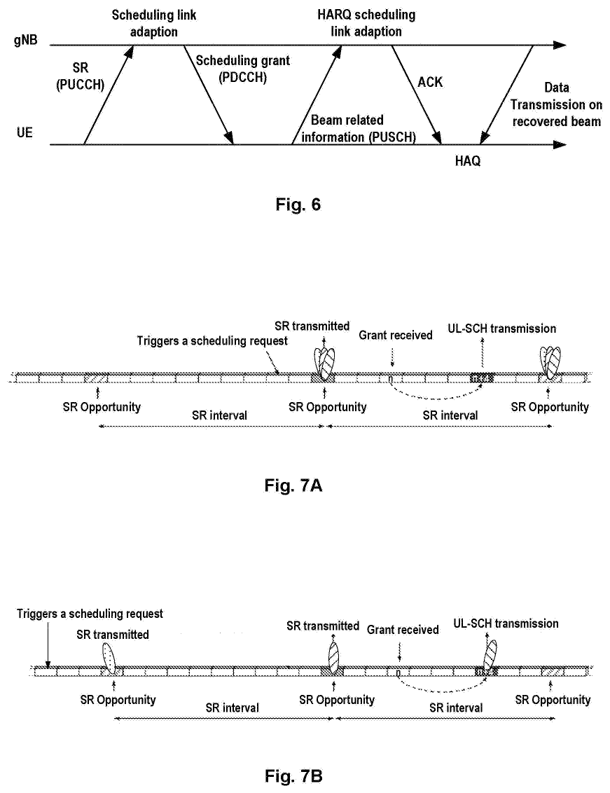

FIG. 6 illustrates an example SR procedure in the NR system according to an embodiment of the present disclosure. As illustrated, the terminal device like UE may send a beam failure recovery request with SR on PUCCH to a network device like gNB. After a scheduling link adaption, the gNB may transmit a scheduling grant on PDCCH. In response to the scheduling grant, the UE may transmit beam related information to the gNB so that the gNB could know information on form example, candidate beams. The beam related information may include, for example, a beam failure identity; a candidate beam identity; a beam power; a failure beam group identity; a candidate beam group identity, a quality gradually dropping beam identity or any combination thereof. Afterwards, in response to an ACK from the gNB, the terminal device may start the data transmission on the recovered beam.

Therefore, in an embodiment of the present disclosure, the terminal device may transmit beam related information to the gNB in response to a scheduling grant, as illustrated in step 403, in FIG. 4.

In an embodiment of the present disclosure, the terminal device may transmit the SR on a plurality of beams available at a scheduling request transmission opportunity. In such a case, it is possible to improve the success possibility of beam failure recovery.

FIG. 7A illustrates an example SR transmission according to an embodiment of the present disclosure. As illustrated in FIG. 7A, when the SR is trigged, the terminal device transmits the SR on for example all beams available at a scheduling request transmission opportunity. Only if each of SR transmissions fails, the terminal device can re-transmit the SR in the following SR opportunity. Due to multiple SR transmissions in a SR transmission opportunity, the success possibility of beam failure recovery can be improved.

In another embodiment of the present disclosure, the terminal device may transmit the SR on one beam at a scheduling request transmission opportunity. In such a case, the transmission resource can be used at an efficient way.

FIG. 7B illustrates an example SR transmission according to an embodiment of the present disclosure. As illustrated in FIG. 7A, the terminal device may transmit a SR on one beam at one scheduling request transmission opportunity. In response to a failure of beam failure recovery attempt on the beam, it would change to another beam for a new beam failure recovery attempt at another SR transmission opportunity.

Thus, in such case, the terminal device may further perform, in response to a failure of beam failure recovery attempt, a beam change for a new beam failure recovery attempt, as illustrated in step 403 of FIG. 4.

In embodiments of the present disclosure, the at least one additional bit can be carried by many ways, for example by one more of: time frequency resource for the scheduling request; a modulation symbol of modulation mode for the scheduling request; a sequence used for the scheduling request; and a cyclic shift used in the scheduling request.

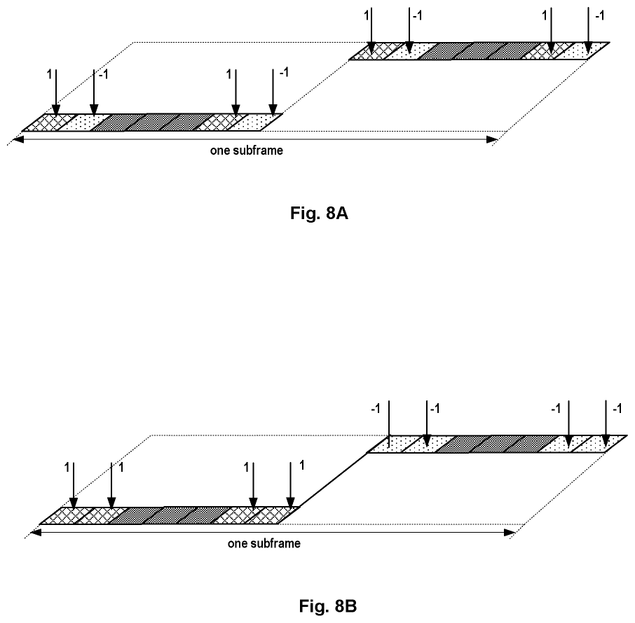

In an embodiment of the present disclosure, the at least one additional bit can be carried by time frequency resource for the scheduling request. In other words, different time frequency resources carrying the SR can be used to indicate different additional information. For illustrative purposes, FIGS. 8A and 8B illustrate example SR resource mappings according to some embodiments of the present disclosure.

As illustrated in FIG. 8A, different values of information bit can be mapped onto different symbols in a slot. As illustrated in FIG. 8A, the value “1” can be mapped onto the first symbol (as illustrated by blocks filled with cross lines) and the value “−1” can be mapped onto the second symbol (as illustrated by blocks filled with dots). By mean of different symbols within a slot, the terminal device may implicitly indicate additional information to the network device like gNB.

FIG. 8B illustrates another example SR resource mapping according to an embodiment of the present disclosure. As illustrated in FIG. 8B, different values of information bit can be mapped onto different slots in a subframe. Particularly, the value “1” can be mapped onto corresponding symbols in the first slot (as illustrated by blocks filled with cross lines) and the value “−1” can be mapped onto corresponding symbols in the second slot (as illustrated by blocks filled with dots). By mean of different slots, the terminal device may implicitly indicate additional information to the network device as well.

In an embodiment of the present disclosure, the at least one additional bit can be carried by a modulation symbol of modulation mode for the scheduling request. In other words, different modulation symbol for modulating the SR can be used to carry the additional information.

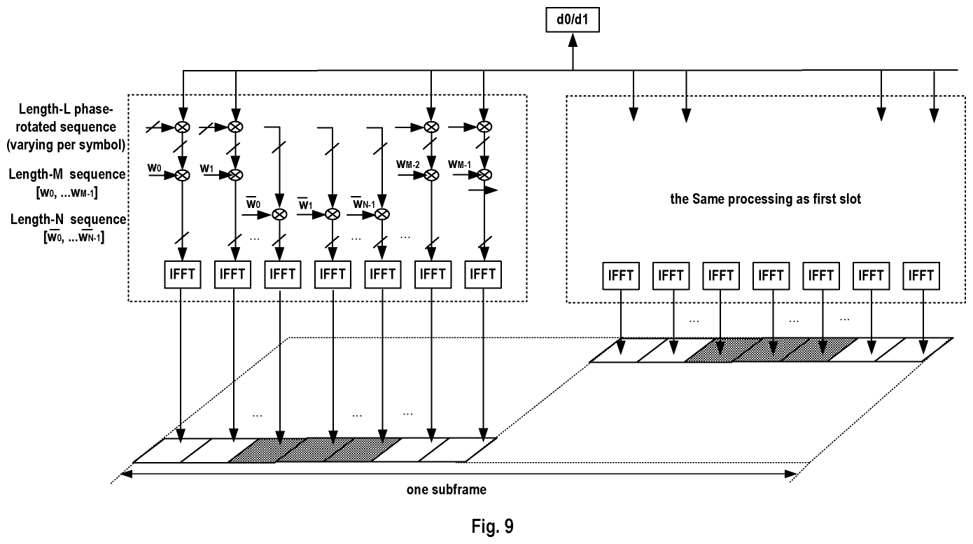

FIG. 9 illustrates an example mapping of SR onto the time-frequency resource according to an embodiment of the present disclosure. As illustrated in FIG. 9, the main difference from those in the LTE lies in that the information bit is modulated and the modulation symbols d0 and d1 is used to indicate for example, 00, 01, 10 and 11, instead of only the presence or absence of the energy. The four different values can be used to indicate for example a scheduling request, a beam failure recovery and other functionalities such as beam switch, scheduling request & beam failure recovery. Thus, it can be seen that different the conventional SR without any modulation, the SR can be modulated with a suitable modulation mode to carrier an additional bit.

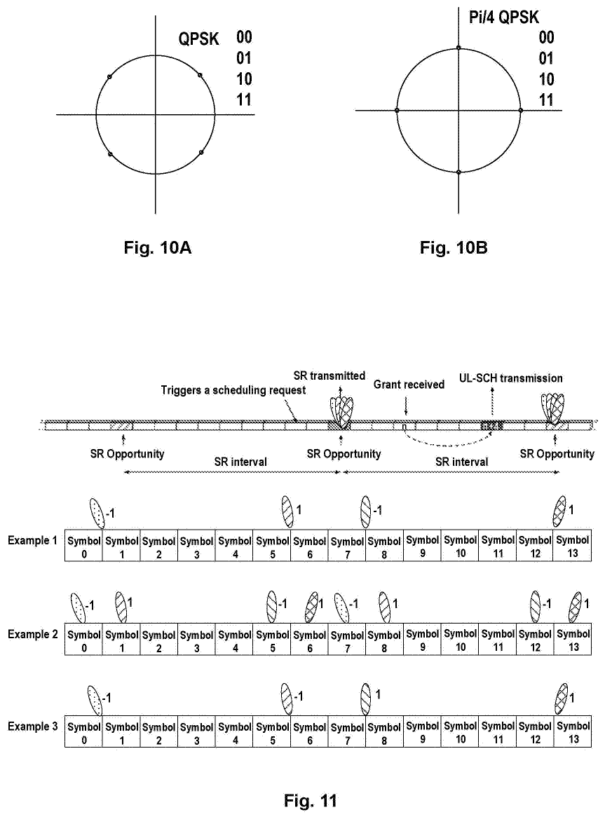

FIG. 10A schematically illustrates an example modulation mode according to an embodiment of the present disclosure. As illustrated in FIG. 10A, it illustrates QPSK which could provide a two-symbol modulation and totally four different modulation symbols, 00, 01, 10, and 11. The modulation symbols could be used to carry additional information, for example to indicate the use of the scheduling request.

FIG. 10B schematically illustrates example modulation mode according to an embodiment of the present disclosure. As illustrated in FIG. 10B, it illustrates Pi/4 QPSK which could also provide a two-symbol modulation and totally four different modulation symbols, 00, 01, 10, and 11, which could be used to carry additional information, for example to indicate the use of the scheduling request.

For different modulation symbols as illustrated in each of FIGS. 10A and 10B, they can be used to indicate for example four functionalities of the SR. Examples of the four uses may include, but not limited to, a scheduling request, a beam failure recovery, a beam switch and scheduling request & beam failure recovery.

In an embodiment of the present disclosure, the modulation symbol “00” can be used to indicate a scheduling request; the modulation symbol “01” can be used to indicate a beam failure recovery; the modulation symbol “10: can be used to indicate a beam switch; and the modulation symbol “11” can be used to indicate scheduling request & beam failure recovery. In another embodiment of the present disclosure, the modulation symbol “00” can be used to indicate a scheduling request; the modulation symbol “01” can be used to indicate a beam switch; the modulation symbol “10 can be used to indicate beam failure recovery; and the modulation symbol “11” can be used to indicate scheduling request &beam failure recovery. In a further embodiment of the present disclosure, the modulation symbol “00” can be used to indicate scheduling request &beam failure recovery; the modulation symbol “01” can be used to indicate a beam switch; the modulation symbol “10 can be used to indicate beam failure recovery; and the modulation symbol “11” can be used to indicate a scheduling request. In a further embodiment of the present disclosure, the modulation symbol “00” can be used to indicate scheduling request & beam failure recovery; the modulation symbol “01” can be used to indicate a beam failure recovery; the modulation symbol “10 can be used to indicate a beam switch; and the modulation symbol “11” can be used to indicate a scheduling request. It shall be appreciated that the above embodiments are just given for illustrative purposes and it is possible to use the above modulation symbols to indicate other uses or functionalities of the SR or use different values of modulation symbols to indicate the above example uses or other uses or functionalities.

In embodiments of the present disclosure, the beams for transmitting different symbols can be combined in any suitable manner; and the beams for carrying information bit can be combined in any suitable manner as well.

FIG. 11 illustrates example SR transmissions according to embodiments of the present disclosure. As illustrated in FIG. 11, in example 1, the value “−1” is mapped onto the first two symbols in the first and second slots and the value “+1” is mapped the last two symbols in the first and second slots; the SRs on the first two symbols within a slot share the same beam and the SRs on the last two symbols within a slot share the same beam, but the beams for the first two symbols and the last two symbols are different from each other and the beams for different slot are also different from each other. In example 2 as illustrated in FIG. 11, the value “−1” is mapped onto the first and sixth symbols in the first and second slots and the value “+1” is mapped the second and seventh symbols in the first and second slots; the SRs within a slot uses different beams, but the beams for corresponding symbols within different slot are same as each other. In example 3 as illustrated in FIG. 1, the value “−1” is mapped onto corresponding symbols in the first slot and the value “+1” is mapped corresponding symbols in the second slot; the SRs on the first two symbols within a slot share the same beam and the SRs on the last two symbols within a slot share the same beam, but the beams for the first two symbols and the last two symbols are different from each other and the beams for different slot are also different from each other.

It shall be appreciated that the above examples are just given for illustration purposes and the present disclosure is not limited thereto and the skilled in the art may conceive any suitable beam combination for carrying the information bit or for transmitting different symbols. It shall be also appreciated that in FIG. 11, there are illustrated 14 symbols; however, it is just for illustrative purposes and in the NR system, there was introduced a new frame structure and thus the number of symbols, the period, the SR possibility may be different from those illustrated.

In addition, for the solutions as illustrated in any of FIG. 8A to FIG. 11, the example SR procedure can be similar to that as illustrated in FIG. 6 and thus detailed description will not be elaborated herein.

In another embodiment of the present disclosure, it is also possible to use modulation modes different from those illustrated in FIGS. 8A and 8B to provide more modulation symbols.

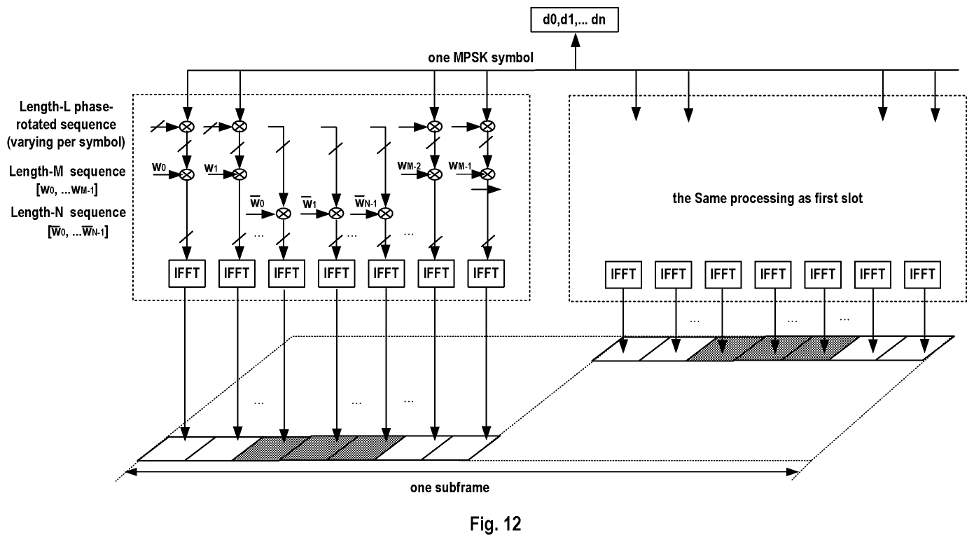

FIG. 12 further illustrates an example mapping of SR onto the time-frequency resource according to an embodiment of the present disclosure. In FIG. 12, the main difference from that in the LTE system lies in that MPSK or other type of modulation can be used and modulation symbols d0, d1, . . . , dn are used to provide more information bits, instead of only the presence or absence of the energy. For example, the Quadrature Amplitude Modulation (QAM) can be used and the additional information to provide n information bit. The additional information may indicate at least two of: a resource request; a beam failure recovery request; a beam change/switch/handover; a beam failure identity; a candidate beam identity; a beam power; a failure beam group identity; a quality gradually dropping beam identity. Thus, it can be seen that different from the conventional SR without any modulation, the SR can be modulated with a suitable modulation mode to carrier an additional bit.

In such a case, the SR transmission can adopt the solution as illustrated in each of FIGS. 7A, 7B, and 11 and thus detailed description will not be elaborated herein.

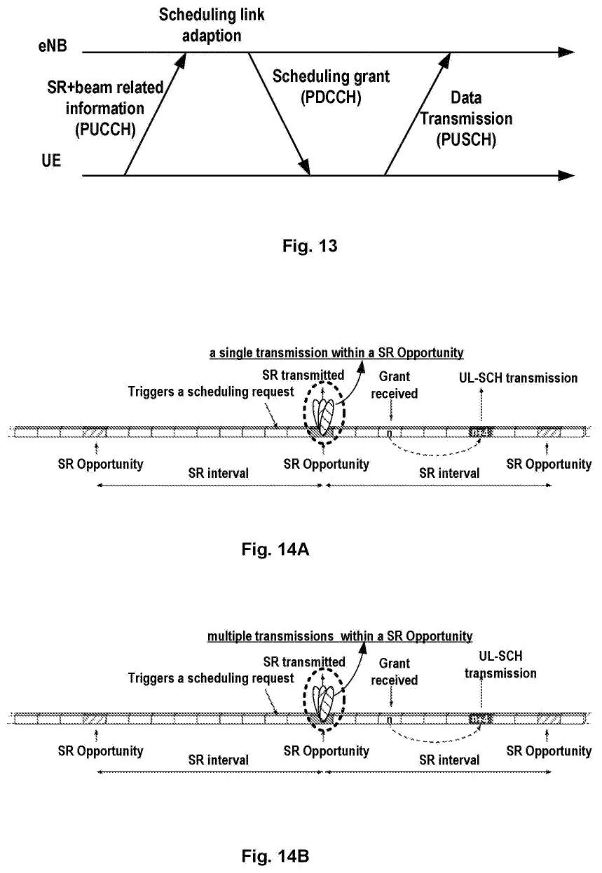

FIG. 13 illustrates a SR procedure according to an embodiment of the present disclosure, wherein the SR is extended to contain n information bit. As illustrated, in such a case, it is possible to transmit the request related information to the gNB together with the SR transmission and thus, in response to the receipt of scheduling grant, the terminal device may directly transmit the data. In a case in which the SR indicates a beam a recovery request, the beam changing can be completed at the second UL transmission.

It shall be appreciated that the time frequency resource and a modulation symbol are only examples for extending the information bit of the SR and the present disclosure is not limited thereto and it is also possible to use other different manners to extend the information bit carried by the SR. For example, the sequence for the scheduling request, like Zadoff-chu sequence, or other Constant Amplitude Zero Auto Correlation (CAZAC) sequence can be divided into different sequence groups which are used to carry different information. Thus, based on the sequence group to which a sequence for the SR belongs, it could implicitly indicate additional information. In addition, cyclic shift (CS) can be also used to extend information bit of the SR in a similar way.

In addition, it shall also be appreciated that the above manners for extend the information bit of the SR can be used separately or in any suitable combination thereof to extend more information bits.

In embodiments of the present disclosure, there are further provided a solution about SR counter on MAC layer. The SR counter is a counter to record the number of SR and if the counter value is higher than the allowable maximum transmission number drs-TransMax (a parameter configured by higher layer), the UE would go to a PRACH transmission. In an embodiment of the present disclosure, any transmission of SR will cause the increase of the SR counter. In another embodiment of the present disclosure, one or more transmissions at a scheduling request transmission opportunity are all counted as only one transmission. Thus, if the scheduling request is transmitted on a plurality of beams available at a scheduling request transmission opportunity, the SR counter is only increased by one, instead of the total number of beams carrying the SR.

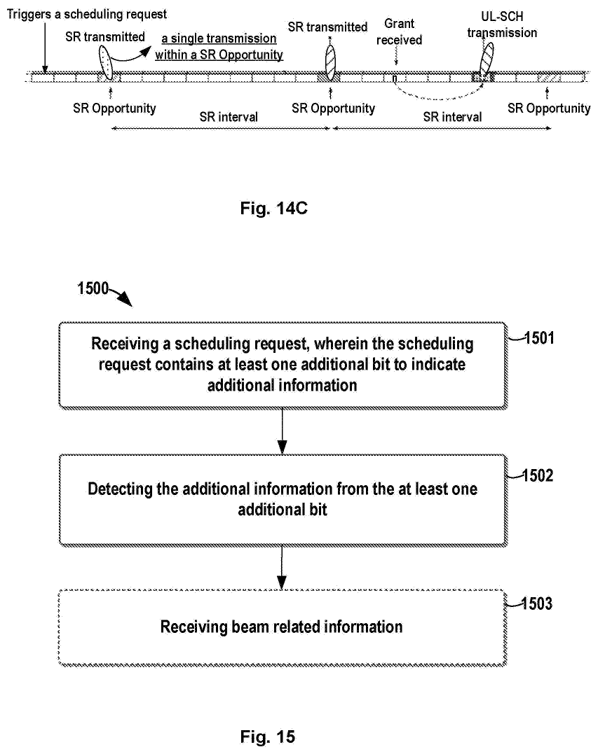

FIGS. 14A to 14C illustrate example SR transmissions counting according to an embodiment of the present disclosure. As illustrated in FIG. 14A, at a SR opportunity, three available beams are used to transmit the SR, however, the transmission of SR is consider as a single one transmission and the SR counter is increased by only one. As illustrated in FIG. 14A, three available beams are used to transmit the SR, and different from FIG. 14A, each transmission is considered as a single transmission. Thus, transmissions on three beams are counted as three transmissions and the SR counter is increased by three. As illustrated in FIG. 14C, at a SR opportunity, only one beam is used to transmit the SR, and thus it is counted as one single transmission and the SR counter is increased by one.

In another embodiment of the present disclosure, there is further provide a new high layer configuration for the scheduling request. in the high layer configuration, it supports more than 2 antenna ports. Hereinbelow, an example high layer configuration is given for illustration purposes.

### Example of High Layer Configuration

| | |
|---|---|
| SchedulingRequestConfig : | CHOICE { |
| release | NULL, |
| setup | SEQUENCE |

```
    sr-PUCCH-ResourceIndex-r13 INTEGER (0..2047),
    sr-PUCCH-ResourceIndexP1-r13 INTEGER (0..2047),
    OPTIONAL
    -- NEED OR
    sr-PUCCH-ResourceIndexP2-r13 INTEGER (0..2047),
    OPTIONAL
    --NEED OR
...............................
    sr-PUCCH-ResourceIndexPn-r13 INTEGER (0..2047),
    OPTIONAL
    --NEED OR
```

| | |
|---|---|
| Sr-ConfigIndex-r13 | INTEGER (0, ..157) |
| Dsr-TransMax-r13 | ENUMBERATED { |
| | n4, n8, n16, n32, n64, spare3, |
| | spare 2, spare 1} |
| } | |
| } | |

wherein the underlined part are new added example to support more than two antenna ports based on UE capability and wherein Pn indicates the maximum port supported by UE.

FIG. 15 schematically illustrates a flow chart of a method of receiving SR at a network device according to an embodiment of the present disclosure. The method could be implemented at a network device like gNB, or other like network devices.

As illustrated in FIG. 15, in step 1501, the gNB may receive a scheduling request, wherein the scheduling request contains at least one additional bit to indicate additional information. In step 1502, the gNB may detect the additional information from the at least one addition bit.

In an embodiment of the present disclosure, the at least one additional bit can be carried by one more of: time frequency resource for the scheduling request; a modulation symbol of modulation mode for the scheduling request; a sequence used for the scheduling request; and a cyclic shift used in the scheduling request.

For example, the gNB may demodulate the SR and based on the demodulation symbols which demodulate the SR successfully, the gNB can know the additional information carried by the SR. As another example, the gNB can determine the symbol or the slot in which the SR is received and based on the information on the symbol and the slot, it is possible to obtain the additional information. As a further example, it is possible to determine the information on the sequence used in the SR; based on the determined sequence information, it may obtain the additional information. As a still further example, it is possible to determine information on the CS used in the SR and based on the determined information on CS, it may obtain the additional information.

In another embodiment of the present disclosure, the scheduling request can be detected on one or more beams configured for a terminal device.

In a further embodiment of the present disclosure, in step 1503, the gNB may further receive beam related information from the terminal device.

In a still further embodiment of the present disclosure, the additional information indicates at least two of: a resource request; a beam failure recovery request; a beam change/switch/handover; a beam failure identity; a candidate beam identity; a beam power; a failure beam group identity; or a candidate beam group identity; or a quality gradually dropping beam identity.

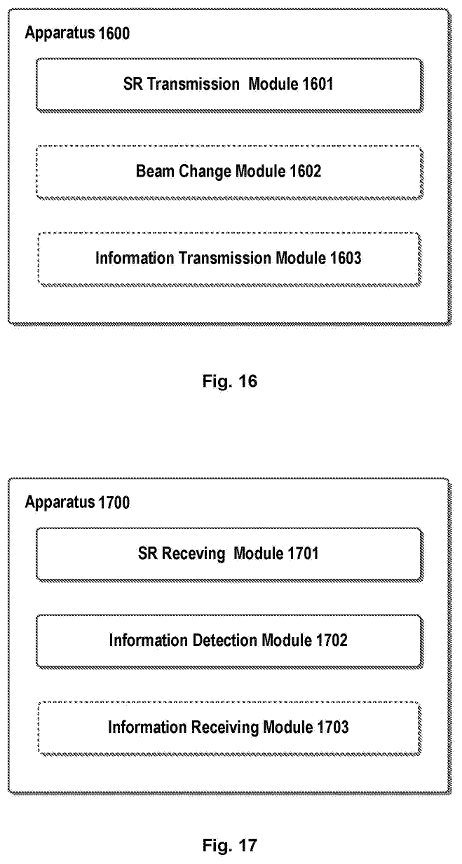

FIG. 16 illustrates an apparatus for transmitting SR at a terminal device according to an embodiment of the present disclosure. The apparatus can be implemented at or in the terminal device like UE or other like terminal devices.

As illustrated in FIG. 16, apparatus 1600 may include a SR transmission module 1601, configured to transmit a scheduling request, wherein the scheduling request contains at least one additional bit to indicate additional information.

In an embodiment of the present disclosure, the at least one additional bit is carried by one more of: time frequency resource for the scheduling request; a modulation symbol of modulation mode for the scheduling request; a sequence used for the scheduling request; and a cyclic shift used in the scheduling request.

In another embodiment of the present disclosure, the modulation mode may comprise at least one of Quadrature Phase Shift Keying (QPSK), Pi/4 QPSK, (multiple phase shift keying) MPSK, or Quadrature Amplitude Modulation (QAM).

In a further embodiment of the present disclosure, different additional information can be mapped onto at least one of: different symbols in a slot; or different slots in a subframe.

In a still further embodiment of the preset disclosure, the scheduling request can be transmitted on a plurality of beams available at a scheduling request transmission opportunity.

In a yet further embodiment of the present disclosure, apparatus 1600 may further include a beam changing module 1602, configured to perform, in response to a failure of beam failure recovery attempt, a beam change for a new beam failure recovery attempt.

In another embodiment of the present disclosure, apparatus 1600 may further comprise: an information transmission module 1603, which is configured to transmit beam related information in response to a scheduling grant.

In a further embodiment of the present disclosure, the additional information indicates at least two of: a resource request; a beam failure recovery request; a beam change/switch/handover; a beam failure identity; a candidate beam identity; a beam power; a failure beam group identity; a candidate beam group identity; or a quality gradually dropping beam identity.

FIG. 17 illustrates an apparatus for receiving SR at a network device according to an embodiment of the present disclosure. Apparatus 1700 can be implemented at or in the network device like gNB or other like network device.

As illustrated in FIG. 17, apparatus 1700 may comprise an SR receiving module 1701 and an information detection module 1702. The request receiving module 1701 can be configured to receive a scheduling request, wherein the scheduling request contains at least one additional bit to indicate additional information. The information detection module 1702 can be configured to detect the additional information from the at least one additional bit.

In an embodiment of the present disclosure, the at least one additional bit can be carried by one more of: time frequency resource for the scheduling request; a modulation symbol of modulation mode for the scheduling request; a sequence used for the scheduling request; and a cyclic shift used in the scheduling request.

In another embodiment of the present disclosure, the scheduling request can be detected on one or more beams configured for a terminal device.

In a further embodiment of the present disclosure, apparatus 1700 can further comprise an information receiving module 1703 configured to receive beam related information.

In a still further embodiment of the present disclosure, the additional information indicates at least two of: a resource request; a beam failure recovery request; a beam change/switch/handover; a beam failure identity; a candidate beam identity; a beam power; a failure beam group identity; a candidate beam group identity; or a quality gradually dropping beam identity.

Hereinbefore, the apparatuses 1600 and 1700 are described with reference to FIGS. 16 and 17 in brief. It is noted that the apparatuses 1600 and 1700 may be configured to implement functionalities as described with reference to FIGS. 4 to 15. Therefore, for details about the operations of modules in these apparatuses, one may refer to those descriptions made with respect to the respective steps of the methods with reference to FIGS. 4 to 15.

It is further noted that components of the apparatuses 1600 and 1700 may be embodied in hardware, software, firmware, and/or any combination thereof. For example, the components of apparatuses 1600 and 1700 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 1600 and 1700 may comprise at least one processor. The at least one processor suitable for use with embodiments of the present disclosure may include, by way of example, both general and special purpose processors already known or developed in the future. Apparatuses 1600 and 1700 may further comprise at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 1600 and 1700 to at least perform operations according to the method as discussed with reference to FIGS. 4 to 15 respectively.

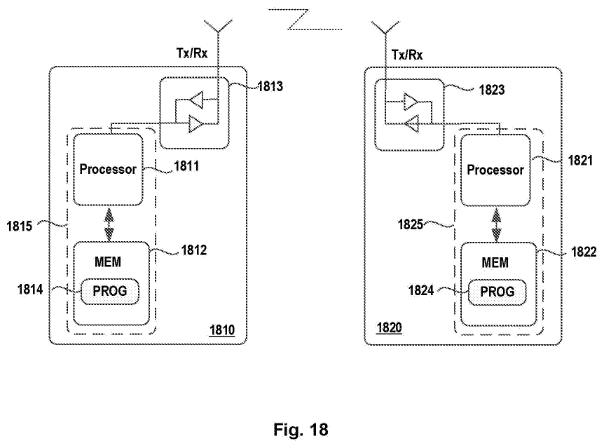

FIG. 18 further illustrates a simplified block diagram of an apparatus 1810 that may be embodied as or comprised in a network device like a base station in a wireless network and an apparatus 1820 that may be embodied as or comprised in a terminal device like UE as described herein.

The apparatus 1810 comprises at least one processor 1811, such as a data processor (DP) and at least one memory (MEM) 1812 coupled to the processor 1811. The apparatus 1810 may further comprise a transmitter TX and receiver RX 1813 coupled to the processor 1811, which may be operable to communicatively connect to the apparatus 1820. The MEM 1812 stores a program (PROG) 1818. The PROG 1814 may include instructions that, when executed on the associated processor 1811, enable the apparatus 1810 to operate in accordance with embodiments of the present disclosure, for example the method 1500. A combination of the at least one processor 1811 and the at least one MEM 1812 may form processing means 1815 adapted to implement various embodiments of the present disclosure.

The apparatus 1820 comprises at least one processor 1821, such as a DP, and at least one MEM 1822 coupled to the processor 1821. The apparatus 1820 may further comprise a suitable TX/RX 1823 coupled to the processor 1821, which may be operable for wireless communication with the apparatus 1810. The MEM 1822 stores a PROG 1824. The PROG 1824 may include instructions that, when executed on the associated processor 1821, enable the apparatus 1820 to operate in accordance with the embodiments of the present disclosure, for example to perform the method 400. A combination of the at least one processor 1821 and the at least one MEM 1822 may form processing means 1825 adapted to implement various embodiments of the present disclosure.

Various embodiments of the present disclosure may be implemented by computer program executable by one or more of the processors 1811, 1821, software, firmware, hardware or in a combination thereof.

The MEMs 1812 and 1822 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 1811 and 1821 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method, comprising:
transmitting a scheduling request, wherein the scheduling request contains at least one additional bit to indicate additional information.

2. The method of claim 1, wherein the at least one additional bit is carried by one more of:
time frequency resource for the scheduling request;
a modulation symbol of modulation mode for the scheduling request;
a sequence used for the scheduling request; and
a cyclic shift used in the scheduling request.

3. The method of claim 2, wherein the modulation mode comprise at least one of Quadrature Phase Shift Keying (QPSK), Pi/4 QPSK, Multiple Phase Shift Keying (MPSK), or Quadrature Amplitude Modulation (QAM).

4. The method of claim 2, wherein different additional information is mapped onto at least one of:
different symbols in a slot; or
different slots in a subframe.

5. The method of claim 1, wherein the scheduling request is transmitted on a plurality of beams available at a scheduling request transmission opportunity.

6. The method of claim 1, further comprising:
performing, in response to a failure of beam failure recovery attempt, a beam change for a new beam failure recovery attempt.

7. The method of claim 1, further comprising:
transmitting beam related information in response to a scheduling grant.

8. The method of claim 1, wherein the additional information indicates at least two of:
a resource request;
a beam failure recovery request;
a beam change/switch/handover;
a beam failure identity;
a candidate beam identity;
a beam power;
a failure beam group identity;
a candidate beam group identity; or
a quality gradually dropping beam identity.

9. A method, comprising:
receiving a scheduling request, wherein the scheduling request contains at least one additional bit to indicate additional information;
detecting the additional information from the at least one additional bit.

10. The method of claim 9, wherein the at least one additional bit is carried by one more of:
time frequency resource for the scheduling request;
a modulation symbol of modulation mode for the scheduling request;
a sequence used for the scheduling request; and
a cyclic shift used in the scheduling request.

11. The method of claim 9, wherein the scheduling request is detected on one or more beams configured for a terminal device.

12. The method of claim 9, further comprising:
receiving beam related information.

13. The method of claim 9, wherein the additional information indicates at least two of:
a resource request;
a beam failure recovery request;
a beam change/switch/handover;
a beam failure identity;
a candidate beam identity;
a beam power;
a failure beam group identity;
a candidate beam group identity; or
a quality gradually dropping beam identity.

14. A terminal device, comprising:
a transceiver configured to transmit a scheduling request, wherein the scheduling request contains at least one additional bit to indicate additional information.

15. The terminal device of claim 14, wherein the at least one additional bit is carried by one more of:
time frequency resource for the scheduling request;
a modulation symbol of modulation mode for the scheduling request;
a sequence used in the scheduling request; and
a cyclic shift used in the scheduling request.

16. The terminal device of claim 14, wherein the scheduling request is transmitted on a plurality of beams available at a scheduling request transmission opportunity.

17. The terminal device of claim 14, wherein the transceiver is further configured to:
transmit, in response to a failure of beam failure recovery attempt, another scheduling request on a changed beam for a new beam failure recovery attempt.

18. The terminal device of claim 14, wherein the transceiver is further configured to transmit beam related information in response to a scheduling grant.

19. The terminal device of claim 14, wherein the additional information may indicate at least two of:
a resource request;
a beam failure recovery request;
a beam change/switch/handover;
a beam failure identity;
a candidate beam identity;
a beam power;
a failure beam group identity;
a candidate beam group identity; or
a quality gradually dropping beam identity.

20.-26. (canceled)
